(19) United States
(12) Patent Application Publication
(10) Pub. No.: US 2024/0320125 A1
(43) Pub. Date: Sep. 26, 2024

(54) TRACING CIRCUIT INCLUDING MEMORY MAPPED TRACE BUFFERS IN NODES OF A MESH NETWORK

(71) Applicant: QUALCOMM Incorporated, San Diego, CA (US)

(72) Inventors: Gaurav Sanjeev Kirtane, Union City, CA (US); Vinod Chamarty, Campbell, CA (US)

(21) Appl. No.: 18/528,225

(22) Filed: Dec. 4, 2023

Related U.S. Application Data
(60) Provisional application No. 63/492,014, filed on Mar. 24, 2023.

(51) Int. Cl. G06F 11/34

(52) U.S. Cl. CPC G06F 11/348; G06F 11/3495

(57) ABSTRACT

Tracing circuits are disposed within each node circuit in a mesh network to debug problems found during development. The tracing circuit disclosed includes a trace read interface for accessing trace packets stored in a trace buffer at entries that are mapped to system memory addresses. Processing circuits coupled to the trace read interface may access the stored trace packets using memory instructions. The trace packets include trace information generated from packets that are detected on selected ports of a node circuit in a node of the mesh network. A filter circuit compares the transaction units to a trace criteria and stores the trace information of the matching packets in the form of trace packets in the memory-mapped entries of the trace buffer. The trace packets can include the transaction units of a packet or just packet header information for more efficient use of the trace buffer.

### PRIORITY APPLICATION

The present application claims priority to U.S. Provisional Patent Application No. 63/492,014, filed Mar. 24, 2023 and entitled “TRACING CIRCUIT INCLUDING MEMORY MAPPED TRACE BUFFERS IN NODES OF A MESH NETWORK,” which is incorporated herein by reference in its entirety.

### BACKGROUND

### I. Field of the Disclosure

The technology of the disclosure relates generally to circuits used for identifying problems in an integrated circuit containing processing circuits interconnected in a mesh network.

### II. Background

Transistor technology developments continue to reduce the sizes of transistors on an integrated circuit (IC), such that system-on-chip (SoC) ICs can include many different processing circuits for performing a large number of operations in parallel. These processing circuits may need to share information with minimal delays. Existing system bus architectures couple multiple users to the same bus, which is used in a time-shared manner. Thus, data transfer operations of a processing circuit may be delayed while another processing circuit is using the bus. As the number of processing circuits increases, the system bus has become a bottleneck in system performance. Mesh networks have been developed to interconnect many processing circuits by multiple paths through different segments of the mesh, allowing packets to be transmitted concurrently on different segments of the mesh. However, due to the complexity of the mesh network and the concurrent data transfers, it can be difficult to determine a source of a problem in an SoC IC that is under development. The designers of SoC ICs need a way to identify the sources of problems found during development by tracking information as it passes through the mesh network. A debugging system can require circuitry to be located in every node of the mesh network. Existing tracing and debug circuits providing general solutions may include unwanted functions and require the IC design to include centralized data storage to which each tracing circuit sends (pushes) its trace data over an additional dedicated trace interface.

### SUMMARY

Aspects disclosed in the detailed description include tracing circuits, including memory-mapped trace buffers in nodes of a mesh network. Methods of tracing packets on a mesh network using tracing circuits with memory-mapped trace buffers are also disclosed. System-on-chip (SoC) integrated circuits (ICs) can include many circuit elements, such as processing circuits (e.g., accelerators, CPUs, GPUs, etc.) and storage circuits, that are each coupled to a mesh network providing a medium for communication and exchange of information. Node circuits located at each node of the mesh network manage the transfer of information in packets comprised of one or more blocks of binary data, referred to herein as transaction units. During the development and debugging of an SoC IC, tracing circuits disposed within each node circuit can be used to monitor activity and debug problems. An exemplary tracing circuit disclosed herein includes a trace read interface for accessing trace packets stored in a trace buffer circuit comprising entries that are mapped to system memory addresses. In this regard, processing circuits coupled to the trace read interface may access the stored trace packets using memory instructions. The trace packets include trace information generated from packets that are detected on selected ports of a node circuit in a node of the mesh network. A filter circuit compares the transaction units to a trace criteria and stores the trace information of the packets matching the trace criteria as trace packets in the memory-mapped entries of the trace buffer circuit. In some examples, the trace packets include the transaction units of a packet. In other examples, the trace packets include packet header information for more efficient use of the trace buffer. Tracing circuits that store trace packets in memory-mapped entries from which a processing circuit can dynamically read the trace packets avoid the need for a centralized trace storage to which multiple trace circuits write their trace data before it can be accessed.

In this regard, in one aspect, an exemplary tracing circuit is disclosed. The tracing circuit comprises an input circuit comprising a plurality of inputs, each configured to couple to one of a plurality of ports of a node circuit at a node in a mesh network. The tracing circuit comprises a filter circuit coupled to the input circuit and configured to receive, from the input circuit, transaction units on a selected input of the plurality of inputs, compare each of the received transaction units to the trace criteria, and in response to a matching transaction unit of the received transaction units matching the trace criteria, generate a trace packet comprising trace information of the matching transaction unit. The tracing circuit also comprises a trace buffer configured to couple to the filter circuit and a trace read interface configured to receive the trace packet from the filter circuit, store the trace packet in a first entry of the trace buffer corresponding to a memory-mapped address, receive a read request comprising the memory-mapped address from the trace read interface, and provide the trace packet in the first entry of the trace buffer to the trace read interface.

In another aspect, an exemplary integrated circuit is disclosed. The integrated circuit comprises a plurality of node circuits, each comprising a plurality of ports coupled to a mesh network and a first processing circuit coupled to one of the plurality of node circuits and configured to execute instructions that access data in a range of memory addresses. The integrated circuit comprises a plurality of tracing circuits, each coupled to one of the plurality of node circuits. Each of the tracing circuits comprises an input circuit coupled to the plurality of ports of the node circuit and a trace buffer configured to couple to a trace read interface. The trace buffer is configured to receive read requests comprising a first memory address, within the range of memory addresses, of a first entry in the trace buffer; and provide a trace packet stored at the first entry to the trace read interface. Each of the tracing circuits also comprises a filter circuit coupled between the input circuit and the trace buffer and is configured to receive, from the input circuit, transaction units on a selected one of the plurality of ports; compare each of the received transaction units to a trace criteria, and in response to a matching transaction unit of the received transaction units matching the trace criteria, store a trace packet comprising trace information of the matching transaction unit in the trace buffer.

In another aspect, an exemplary method of tracing packets in a mesh network is disclosed. The method comprises receiving, from an input circuit comprising a plurality of inputs, each coupled to one of a plurality of ports of a node circuit at a node in a mesh network, transaction units on a selected one of the plurality of inputs, comparing each of the received transaction units to a trace criteria, and in response to a matching transaction unit of the received transaction units matching the trace criteria, generating a trace packet comprising trace information of the matching transaction unit. The method further comprises storing the trace packet in a first entry of a trace buffer corresponding to a memory-mapped address, receiving a read request comprising the memory-mapped address from a trace read interface, and returning the trace packet in the first entry of the trace buffer to the trace read interface.

### BRIEF DESCRIPTION OF THE DRAWINGS

FIG. 1 is a block diagram of one example of an exemplary tracing circuit that traces packets on a selected node in a mesh network and stores trace packets in a memory-mapped trace buffer circuit accessed by a trace read interface;

FIG. 2 is a diagram of an example of an IC including a mesh network including circuit elements coupled to node circuits at each node and instances of the tracing circuit of FIG. 1 coupled to the node circuits;

FIGS. 3A and 3B are diagrams illustrating fields of various types of trace packets stored in debug registers in the trace buffer circuit in FIG. 1;

FIG. 4 is a flow chart of an exemplary method of tracing packets in the tracing circuit in FIG. 1;

FIG. 5 is a timing diagram illustrating the timing of global timestamps and local timestamps that are stored when a first transaction unit of a packet matches a trace criteria in the tracing circuit of FIG. 1;

FIG. 6 is a block diagram of the filter circuit in the tracing circuit in FIG. 1 for controlling the tracing of packets in a mesh network;

FIG. 7 is a block diagram of the match/mask logic in the filter circuit of FIG. 6;

FIG. 8 is a block diagram of an exemplary wireless communication device that includes radio-frequency (RF) components that can include tracing circuits, including memory-mapped trace buffers in node circuits of a mesh network for system monitoring and debugging, as illustrated in FIGS. 1, 2, 6, and 7 and according to, but not limited to, any of the exemplary methods of tracing packets in the flowchart in FIG. 4; and

FIG. 9 is a block diagram of an exemplary processor-based system that can include, and according to, but not limited to, any of the exemplary methods of tracking communication units in FIG. 4.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include tracing circuits, including memory-mapped trace buffers in nodes of a mesh network. Methods of tracing packets on a mesh network using tracing circuits with memory-mapped trace buffers are also disclosed. System-on-chip (SoC) integrated circuits (ICs) can include many circuit elements, such as processing circuits (e.g., accelerators, CPUs, GPUs, etc.) and storage circuits, that are each coupled to a mesh network providing a medium for communication and exchange of information. Node circuits located at each node of the mesh network manage the transfer of information (data) in packets comprised of one or more blocks of binary data, referred to herein as transaction units. During the development and debugging of an SoC IC, tracing circuits disposed within each node circuit can be used to monitor activity and debug problems. An exemplary tracing circuit disclosed herein includes a trace read interface for accessing trace packets stored in a trace buffer circuit comprising entries that are mapped to system memory addresses. In this regard, processing circuits coupled to the trace read interface may access the stored trace packets using memory instructions. The trace packets include trace information generated from packets that are detected on selected ports of a node circuit in a node of the mesh network. A filter circuit compares the transaction units to a trace criteria and stores the trace information of the packets matching the trace criteria as trace packets in the memory-mapped entries of the trace buffer circuit. In some examples, the trace packets include the transaction units of a packet. In other examples, the trace packets include packet header information for more efficient use of the trace buffer. Tracing circuits that store trace packets in memory-mapped entries from which a processing circuit can dynamically read the trace packets avoid the need for a centralized trace storage to which multiple trace circuits write their trace data before it can be accessed.

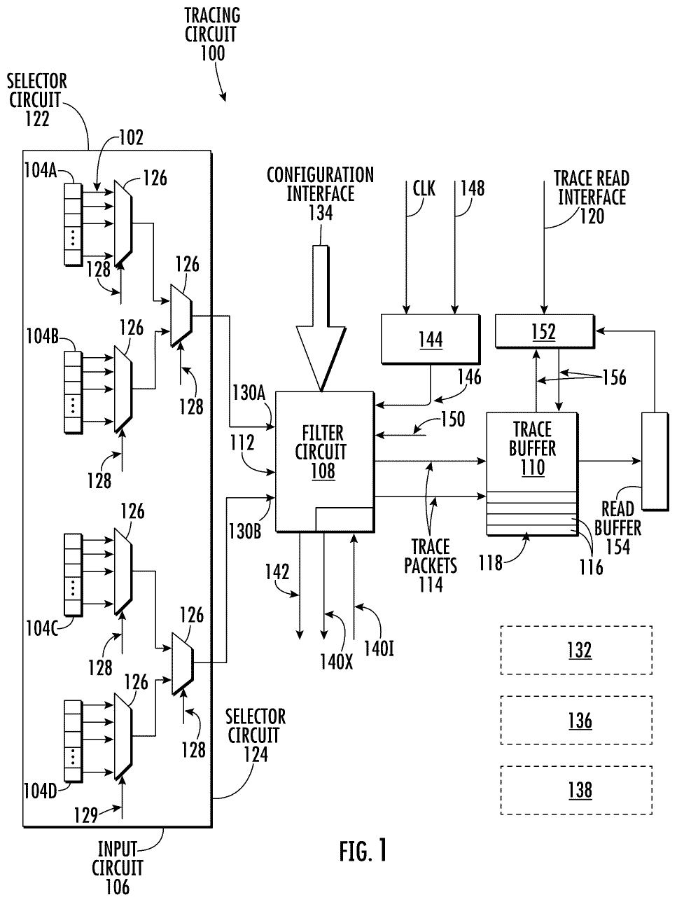

In this regard, FIG. 1 is a block diagram of one example of an exemplary tracing circuit 100 that detects packets 102 on inputs 104A, 104B, 104C, and 104D (collectively inputs 104) of an input circuit 106. The inputs 104 may be coupled to multiple ports of a node circuit (not shown) in a mesh network over which the packets 102 are transmitted. The tracing circuit 100 also includes a filter circuit 108 coupled between the input circuit 106 and a trace buffer circuit 110 (“trace buffer 110”). The filter circuit 108 receives packets from selected ports coupled to the inputs 104 and compares the packets 102 to a trace criteria 112. For packets 102 that match the trace criteria 112, the filter circuit 108 constructs and stores trace packets 114 in entries 116 of the trace buffer 110. The trace packets 114 contain trace information 118 in or about the matching packet 102. The entries 116 are mapped to memory-mapped addresses within a range of memory addresses accessible by the processing circuits in an SoC IC, and the entries 116 may be accessed by read requests to the corresponding memory addresses received on a trace read interface 120. The processing circuits reading the entries 116 may include a central processing unit (CPU), a trace control circuit, or a service processor, for example.

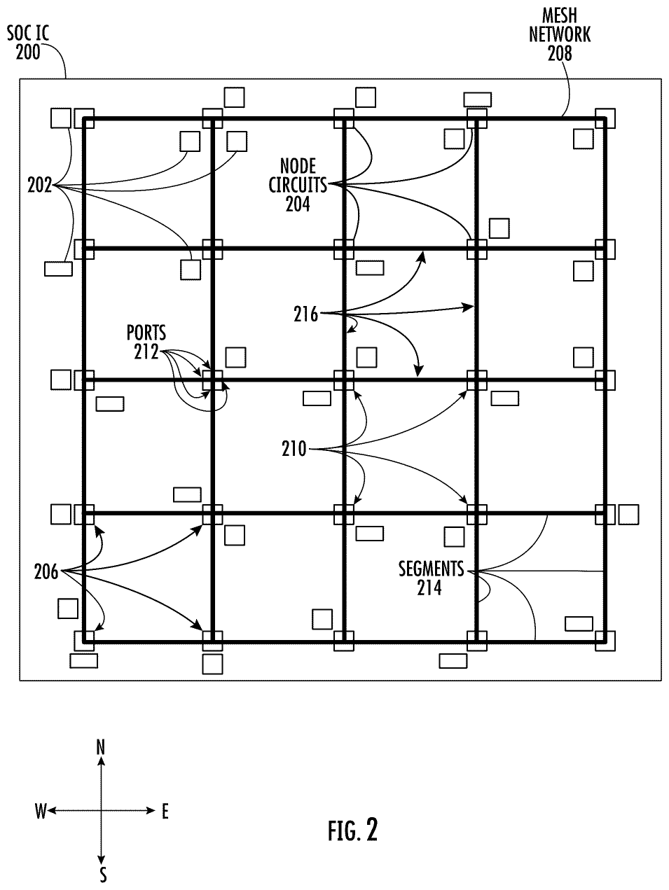

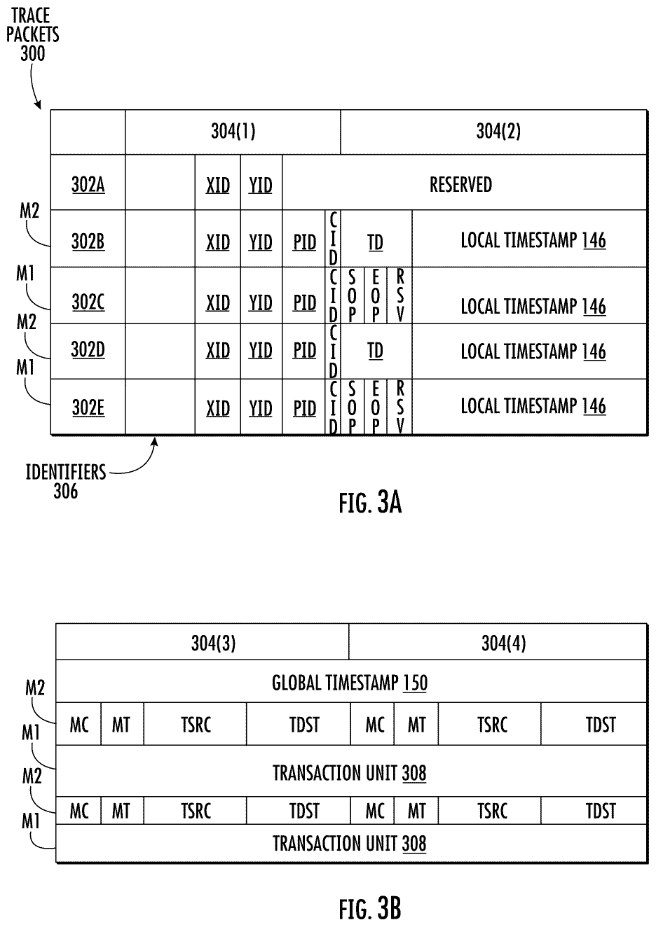

Before continuing in detail regarding aspects of FIG. 1, reference is made to FIG. 2. FIG. 2 is an illustration of an exemplary SoC IC 200, including circuit elements 202 coupled to node circuits 204 at each node 206 of a mesh network 208. The SoC IC 200 includes tracing circuits 210, which can be the tracing circuits 100 in FIG. 1, to provide exemplary context of how the tracing circuit 100 could be employed in an SoC IC. The node circuits 204 each include a tracing circuit 210, which may be the tracing circuit 100 in FIG. 1, disposed in each of the node circuits 204. The node circuits 204 include the tracing circuits 210 for monitoring packets of information transmitted in the mesh network 208. The node circuits 204 include ports 212 (e.g., ingress ports and egress ports) on the north, south, east, and/or west sides of the node circuits 204. Circuit elements 202 and segments 214 of the mesh network 208 couple to the ports 212 and intersect at the nodes 206. Information transferred among the circuit elements 202 is routed through one or more of the node circuits 204. Each of the node circuits 204 has a unique identifier. Since the nodes 206 are organized in a grid pattern, as shown in FIG. 2, the unique identifier may include an X coordinate identifier (XID) and a Y coordinate identifier (YID) (See FIG. 3A). The information arriving on ingress ports and departing on egress ports of the ports 212 through the mesh network 208 may be monitored by the tracing circuits 210. The information transmitted arriving at the ports 212 from the circuit elements 202 and the segments 214 is formatted as packets 216, which may be the packets 102 in FIG. 1. When one of the packets 216 matches a trace criteria, information in and about the matching packet 216 can be stored in the tracing circuit 210.

Returning to FIG. 1, further exemplary details of the tracing circuit 100 are provided before explaining the formats of the packets 102, 216 in more detail below with reference to FIGS. 3A and 3B. The inputs 104 of the input circuit 106 are inputs to selector circuits 122 and 124, each including selection circuits 126, which may be multiplexors 126, controlled by control signals 128. The selector circuit 122 couples to the inputs 104A and 104B may be ingress inputs coupled to ingress ports of the node circuits 204 in FIG. 2. The selector circuit 124 couples to the inputs 104C and 104D may be egress inputs coupled to egress ports from the node circuits 204 in FIG. 2. The first and second selector circuits 122 and 124 couple to filter circuit inputs 130A and 130B. The control signals 128 may be provided from configuration registers 132. The configuration registers 132 may be programmed (e.g., written to) over a configuration interface 134. Thus, by programming the configuration registers 132, the first and second selector circuits 122 and 124 couple a selected one of the ingress inputs 104A, 104B and a selected one of the egress inputs 104C, 104D to filter circuit inputs 130A and 130B.

In addition to the configuration registers 132, the configuration interface 134 may also be used to program match registers 136 and mask registers 138, which provide the trace criteria 112 to which the packets 102 are compared. Packets 102 provided to each of the filter circuit inputs 130A and 130B are compared to the match registers 136 and mask registers 138, as explained further below. The match registers 136 and the mask registers 138 may be internal to or external to the filter circuit 108 but are within the tracing circuit 100. The configuration registers 132 control the input circuit 106 and the filter circuit 108.

Operation of the tracing circuit 100 may be activated and deactivated by the incoming trigger signal 1401, which is provided to trigger the tracing circuit 100 to initiate tracing and to stop tracing. For example, in response to a first pulse or brief change in voltage (e.g., between a reference voltage VSS and a power supply voltage VDD) on the trigger signal 1401, the filter circuit 108 may initiate comparing packets 102 received on the filter circuit inputs 130A and 130B to the trace criteria 112 and storing matching packets in the trace buffer 110. In response to a next pulse on the trigger signal 1401, the filter circuit 108 may stop comparing and storing packets. In this manner, a pulse may alternately turn on and turn off tracing. The trigger signal 1401 may be used in other well-known manners to initiate and terminate tracing.

The trace buffer 110 may be operated in either a wrapping mode or a non-wrapping mode. As trace packets 114 are received in the trace buffer 110, the trace packets 114 are stored in available entries 116 (e.g., sequential entries). An entry 116 is available until a trace packet 114 has been stored and the entry 116 becomes available again after the trace packet 114 has been read from that entry 116. The entry 116 may also become available in response to the entries 116 being flushed, marked as invalid, or by another related mechanism indicating that the trace packet 114 stored in an entry 116 is no longer needed and may be overwritten. Eventually, the trace buffer 110 is filled with trace packets 114 that have not yet been read by the processing circuits of the SoC IC. In the wrapping mode, after a trace packet 114 is stored in a last available entry 116, a trace packet 114 already stored in a first entry 116 is overwritten (even though such entry 116 is not available) and subsequent entries 116 are over-written in sequence, for example. In this manner, the trace packets 114 stored in the trace buffer 110 are always the most recently stored trace packets 114 at the time tracing is halted, e.g., due to a next pulse of the trigger signal 1401.

In the non-wrapping mode, trace packets 114 are stored in the trace buffer 110 after tracing is initiated by a first pulse of the trigger signal 1401, until the trace buffer 110 is filled and there are no available entries 116. In other words, when there are no more entries 116 into which trace packets 114 may be written without over-writing a trace packet 114 that has not yet been read or otherwise indicated as unneeded, the trace buffer stops storing packets 114 in the trace buffer 110. In this manner, there is a maximum number (e.g., corresponding to the number of entries 116) of trace packets 114 that may be stored in the trace buffer 110 after tracing is initiated by the trigger signal 1401, and they will not be overwritten.

The outgoing trigger signal 140X may be provided to other tracing circuits 100 or to other circuitry employed for debugging or monitoring, for example, informing them that tracing has been initiated and/or should be initiated. In some examples, the trigger signal 140X may be used to pass on the incoming trigger signal 1401 to the tracing circuits 100 in other node circuits. The outgoing trigger signal 140X may also indicate, in the non-wrapping mode, that the trace buffer 110 has been filled (e.g., the last available entry 116 has been written) and can't store any new trace packets 114. In the wrapping mode, the outgoing trigger signal 140X may indicate that the trace buffer 110 has been filled, even though entries 116 continue to be over-written with new trace packets 114. The filter circuit 108 also generates a system event indication 142 that may be used to indicate the detection of a particular packet 102 meeting certain trace criteria 112, where such packet 102 may indicate a system event.

The tracing circuit 100 also includes a counter 144 used to provide a local timestamp 146 to the filter circuit 108. The local timestamp 146 can be used to track the relative arrival times of packets 102 matching the trace criteria 112, causing trace packets 114 to be stored in the entries 116 of the trace buffer 110. The entries 116 are storage locations within the trace buffer 110, which may be flip-flops or another kind of register circuit, or SRAM memory. The counter 144 increments periodically in response to a clock signal CLK. The counter 144 may receive a counter configuration signal 148 to control an aspect of the counter 144, such as the counter granularity and/or maximum rollover value. The period between rollovers of the counter 144 may be referred to as a local epoch. The filter circuit 108 also receives a global timestamp 150, which is employed for synchronization to other tracing circuits 100 and processing circuits, such as the circuit elements 202 in FIG. 2. The periodicity of the global timestamp 150 may be unrelated to the local epoch of the counter 144. However, the global timestamp 150 and the local timestamp 146 can be used to track the relative times at which trace packets 114 are stored in the trace buffer 110 and stored in other tracing circuits 100 for purposes of monitoring system operation and failure analysis.

The tracing circuit 100 includes a read control circuit 152 coupled to the trace buffer 110 and the trace read interface 120, and a read buffer 154 coupled to the trace buffer 110 and the read control circuit 152. The read control circuit 152 employs signals 156 to access packet 102 stored in the entries 116 corresponding to memory-mapped addresses received in a read request on the trace read interface 120 and stores the accessed packet 102 in the read buffer 154. The read control circuit 152 also couples the read buffer 154 to the trace read interface 120 or otherwise provides the addressed trace packet 114 stored in the read buffer 154 to the trace read interface 120.

Additional details of the operation of the tracing circuit 100, and in particular the filter circuit 108, are provided below with reference to FIGS. 3A, 3B, 5, and 6.

FIGS. 3A and 3B are diagrams illustrating trace packets 300 of trace packet types 302A-302E, which are some of the examples of the trace packets 114 that may be stored in the entries 116 of the trace buffer 110 in FIG. 1. The trace packets 300 may have other formats, numbers of bits, and types of information, for example. The description of the trace packets 300 may include references to enumerated features of FIGS. 1 and 2, which are not shown in FIGS. 3A and 3B. The trace packets 300 are generated from information in or about packets 102 in the filter circuit 108 in FIG. 1.

All of the trace packet types 302A-302E are arranged in trace packet fields 304(1)-304(4). In the first trace packet field 304(1), each of the trace packet types 302A-302E includes identifiers 306, indicating the trace packet types 302A-302E. The first trace packet field 304(1) also contains the X coordinate identifier XID and the Y coordinate identifier YID of the node circuit 204 corresponding to the trace circuit 100.

Additional details of the trace packet types 302A-302E are readily understood in view of the mode feature of the tracing circuit 100 presented with reference to FIGS. 1, 3A, and 3B. The capacity of the tracing buffer 110 may be limited by the amount of area allotted in an IC for storing trace information that is used only for purposes of analysis during development, especially considering that there is one tracing circuit 100 at every node 206 in a mesh network 208. To optimize the use of the available trace information storage capacity, the tracing circuit 100 can be configured to operate in a first tracing mode M1, in which more detail is provided, but for a smaller number of the packets 102, when adequate. In this mode, the tracing circuit 100 employs trace packet types 302C and 302E. In a second tracing mode M2, fewer details of the respective packets 102 are stored, but information regarding a greater number of packets 102 can be saved. In the second tracing mode M2, the tracing circuit 100 employs trace packet types 302B and 302D. As understood by persons of ordinary skill, other modes and trace packet types may be employed.

In both the first tracing mode M1 and the second tracing mode M2, a trace packet 300 of the trace packet type 302A is stored in response to one of the packets 102 matching the trace criteria 112 after receiving the incoming trigger signal 1401. The trace packet type 302A includes the current global timestamp 150, which is 64 bits in length, in this example, stored in the third and fourth trace packet fields 304(3) and 304(4). The trace packet type 302A has bits in the first trace packet field 304(1) and the second trace packet field 304(2) that may be used for any desired purpose. The trace packet type 302A is stored in addition to at least one of the trace packet types 302B-302E.

Each of the trace packet types 302B-302E further includes, in the first trace packet field 304(1), a port identifier PID indicating the input 104 from which the packet 102 (which triggered the creation of a trace packet 300) was received and a channel identifier CID (e.g., identifying a virtual channel). Each of the trace packet types 302B-302E also includes the local timestamp 146 in the second trace packet field 304(2). The remaining contents of the second to fourth trace packet fields 304(2)-304(4) depend on whether the tracing circuit 100 is operating in the first tracing mode M1 or the second tracing mode M2.

The trace information stored in the third and fourth trace packet fields 304(3) and 304(4) of the trace packet types 302B-302E is taken from the packets 102 that match the trace criteria 112. The packets 102 include one or more blocks of binary data referred to herein as transaction units 308. The packets 102 are transmitted as a sequence of blocks of binary data, each block comprising one of the transaction units 308. Thus, the transaction units 308 may be detected on the selected one of the inputs 104 in one or more consecutive cycles. The transaction units 308 are blocks of binary data, which may also be known as flow control units (FLITs). In some examples, there may be any number from one (1) to eight (8) transaction units 308, or more, per packet 102. In this example, the transaction units 308 are 64 binary digits (bits) in length, and the trace packets 300 are generated with one hundred (100) bits each. Therefore, the first to fourth trace packet fields 304(1)-304(4) in any of the trace packet types 302A-302E have a combined total of 100 bits, and the entries 116 in the trace buffer in FIG. 1 each store 100 bits of digital information.

A first transaction unit of a packet 102 may include information about the packet 102, such as indicating the number of additional transaction units 308 included in the packet 102 following the first transaction unit. In addition, the first transaction unit may include information about the message being transmitted in the packet 102, such as a message class MC and message type MT. Transaction units 308 following the first transaction unit in a packet 102 may contain data corresponding to the message type MT and message class MC. The first transaction unit may also indicate a transaction source TSRC and transaction destination TDEST, which identify the circuit elements 202 (see FIG. 202) that are the source and destination of transmission of the packet 102.

The trace packets 300 generated from the packets 102 in the first tracing mode M1 employ the trace packet types 302C and 302E. The filter circuit 108 may generate one of the trace packets 300 for each of the transaction units 308 in a matching packet (not shown), with the entire 64 bits of the transaction unit 308 stored in the third and fourth trace packet fields 304(3) and 304(4) of the trace packet types 302C and 302E. In addition to the contents of the first and second trace packet fields 304(1) and 304(2), described above, the trace packet types 302C and 302E also include start-of-packet SOP and end-of-packet EOP bits in the second trace packet field 304(2). The start-of-packet SOP being set in a trace packet 300 indicates that the transaction unit 308 in the third and fourth trace packet fields 304(3) and 304(4) is the first transaction unit of a packet 102. The end-of-packet EOP being set in a trace packet 300 indicates that the transaction unit 308 in the third and fourth trace packet fields 304(3) and 304(4) is the last transaction unit 308 of a packet 102. In a packet 102, having only one transaction unit 308, both the start-of-packet SOP and the end-of-packet EOP may be set.

The trace packet types 302C and 302E differ from each other only with regard to whether the packet 102 received in the second tracing mode M1 was received at the filter circuit input 130A or the filter circuit input 130B. In other words, in the first tracing mode M1, the trace packet type 302C is used for packets 102 detected on an ingress input 104A or 104B, and the trace packet type 302E may be used for packets 102 detected on an egress input 104C or 104D.

Similarly, the trace packet types 302B and 302D differ from each other with regard to whether the matching packet 102 was received in the second tracing mode M2 at the filter circuit input 130A or the filter circuit input 130B, but they are the same in other aspects. In the second tracing mode M2, one of the trace packet types 302B and 302D is generated in response to a first transaction unit (e.g., a packet header) of a first packet 102 matching the trace criteria 112. In this example, the third trace packet field 304(3) contains the message type MT, message class MC, transaction source TSRC, and transaction destination TDEST from the first transaction unit of the first matching packet 312. In addition, the fourth trace packet field 304(4) of the trace packet types 302B and 302D may contain the same information (e.g., MT, MC, TSRC, and TDEST) from a second packet 102 matching the trace criteria 112. Furthermore, since the trace packet type 302A containing the current global timestamp 150 will be generated in response to the first matching packet causing the filter circuit 108 to generate one of the trace packet types 302B and 302D, timing information regarding the next matching packet 102 may be needed for debug purposes. In this regard, the second trace packet field 304(2) in the trace packet types 302B and 302D also includes a packet-to-packet time delta TD indicating a separation in time between the first matching packet and the second matching packet. Naturally, a limited number of bits are available for the time delta TD. Therefore, if the second trace packet does not arrive within the maximum time delta TD (e.g., based on the limited number of bits) after the first matching packet 312, the fourth trace packet field 304(4) of the trace packet type 302B or 302D generated due to the first matching packet will remain empty, and the transaction unit 308 with the next matching packet (e.g., second trace packet) will cause a new trace packet type 302A and a new trace packet type 302B (or 302D) to be generated.

It should be understood that the above descriptions of the tracing modes M1 and M2, the trace packet types 302A-302E, the trace packet fields 304(1)-304(4), and the trace information stored therein are merely examples. Alternatives to such configurations and trace information may be apparent in view of the present disclosure.

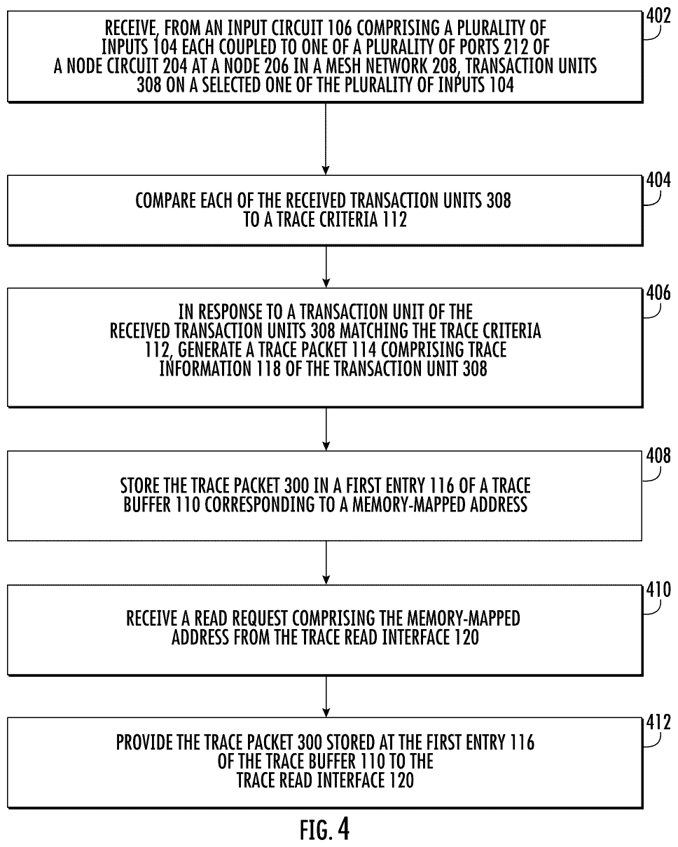

FIG. 4 is a flow chart of an exemplary method 400 of tracing packets 102 in the tracing circuit 100 in FIG. 1. The method includes receiving, from an input circuit 106 comprising a plurality of inputs 104 each coupled to one of a plurality of ports 212 of a node circuit 204 in a mesh network 208, transaction units 308 on a selected one of the plurality of inputs 104 (block 402). The method includes comparing each of the received transaction units 308 to a trace criteria 112 (block 404) and, in response to a transaction unit of the received transaction units 308 matching the trace criteria 112, generating a trace packet 114 comprising trace information 118 of the matching transaction unit 308 (block 406). The method further includes storing the trace packet 300 in a first entry 116 of a trace buffer 110 corresponding to a memory-mapped address (block 408). The method also includes receiving a read request comprising the memory-mapped address from the trace read interface 120 (block 410) and providing the trace packet 300 stored in the first entry 116 of the trace buffer 110 to the trace read interface 120 (block 412).

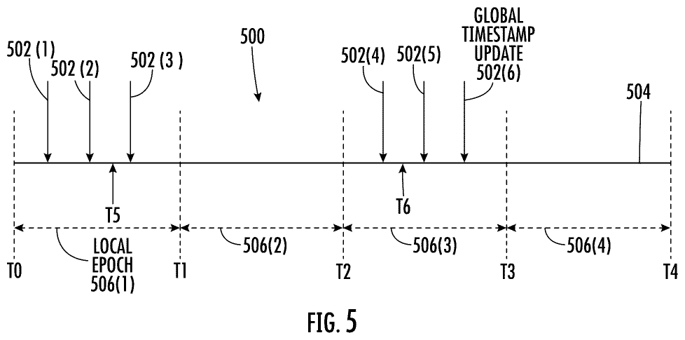

FIG. 5 is a timing diagram 500 illustrating the timing of global timestamp updates 502(1)-502(6) corresponding to the global timestamp 150. The global timestamp updates 502(1)-502(6) may be received on a global timestamp interface (not shown) to the trace circuit 100 in FIG. 1. A most recent one of the global timestamp updates 502(1)-502(6) is saved in the trace packet 300 when a transaction unit 308 in a packet 102 matches a trace criteria 112 in the filter circuit 108, as described with reference to FIGS. 1, 2, 3A, and 3B.

The timing diagram 500 shows time increasing from left to right along the axis 504 and shows the time divided into four (4) local epochs 506(1)-506(4). Each of the local epochs 506(1)-506(4) is an amount of time measured by a counter 144 in the tracing circuit 100 in FIG. 1. The counter 144 increments with each cycle of a system clock CLK (not shown), for example. The counter 144 may be a digital counter whose value rolls over from a maximum value (“FFFFF”) to all zeros (“00000”) at times T0, T1, T2, T3, and T4. FIG. 5 shows each of the global timestamp updates 502(1)-502(3) received in the filter circuit 108 during the first local epoch 506(1), between times T0 and T1.

At time T5, between the global timestamp updates 510(2) and 510(3), a transaction unit 308 of a packet 102 is determined to match the trace criteria 112. For example, the trigger signal 1401 in FIG. 1 may have been received in the filter circuit 108 to initiate comparing transaction units 308 of packets 102 received on the filter circuit inputs 130A and 130B to the trace criteria 112. As discussed above, at time T5, the filter circuit 108 determines that a transaction unit 308 is a first transaction unit 308 of a packet 102 and matches the trace criteria 112. In response to the matching, the filter circuit 108 generates a trace packet 300 of the trace packet type 302A, which includes the current global timestamp provided by the global timestamp update 502(2). The filter circuit 108 also generates a second trace packet 300 in one of the trace packet types 302B-302E. To more precisely track the time at which a transaction unit matches the trace criteria 112, the second trace packet 300 includes a local timestamp 512 (corresponding to the local timestamp 146 in FIG. 1) based on the counter 144 and stored in the second trace packet field 304(2). Similarly, in local epoch 506(3), at time T6, another transaction unit match is detected. In response, a first trace packet 300 of trace packet type 302A is generated, and the most recent global timestamp update 502(4) is stored in the third and fourth trace packet fields 304(3)-304(4). The filter circuit 108 also generates a second trace packet 300 having one of the trace packet types 302B-302E and including the local timestamp 146 in the second trace packet field 304(2) based on the counter 144. Although no updates to the global timestamp 150 are shown in FIG. 5 during the local epochs 506(2) and 506(4), such updates would be occurring as in local epochs 506(1) and 506(3). However, they would not be saved because there are no transaction units 308 matching the trace criteria 112 and no trace packets 300 of the first trace packet type 302A being generated during these local epochs.

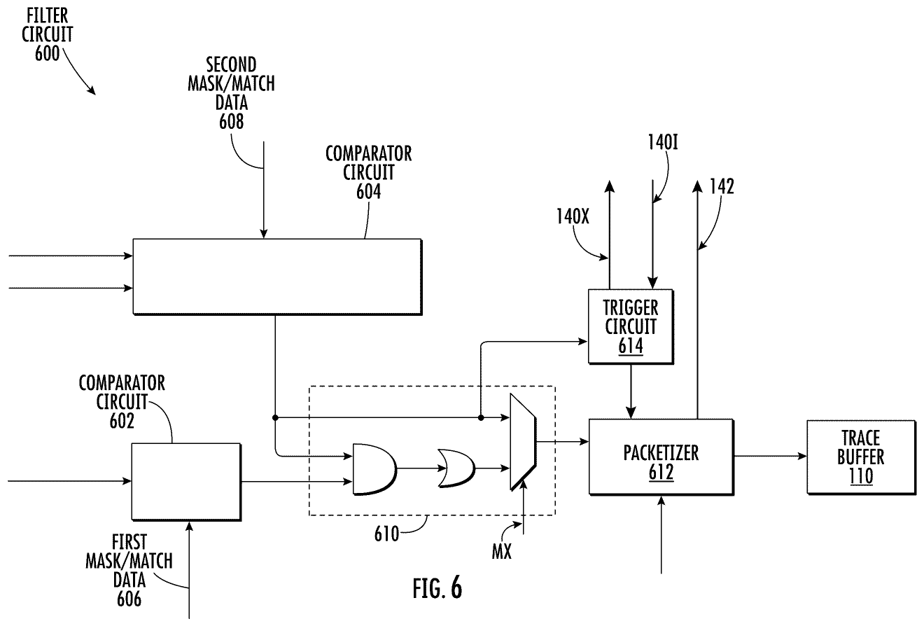

FIG. 6 is a block diagram of one example of a filter circuit 600 corresponding to the filter circuit 108 in the tracing circuit 100 in FIG. 1. The filter circuit 600 controls the tracing of packets 102 in a mesh network, such as the mesh network 208 in FIG. 2. The filter circuit 600 is described with reference to elements illustrated in FIGS. 1-3B.

The filter circuit 600 includes comparator circuits 602 and 604, which are used in the first tracing mode M1 and the second tracing mode M2, respectively, to compare received transaction units 308 to the trace criteria 112. The comparator circuit 602 compares features of transaction units 308 to first match/mask data 606 in tracing mode M1. The comparator circuit 604 compares features of a first transaction unit (e.g., a packet header transaction unit) of each packet 102 to the second match/mask data 608 in tracing mode M2. In some examples, the message class MC and message type MT of a first transaction unit of a packet are compared to the second match/mask data 608. The first match/mask data 606 and the second match/mask data 608 are stored in the match registers 136 and the mask registers 138 described with reference to FIG. 1, which may be internal or external to the filter circuit 600 and, therefore, are not shown here.

The filter circuit 600 includes mode selection logic 610 that receives results of the comparisons in the comparator circuits 602 and 604, which may be used together or individually, depending on a mode signal MX indicating the tracing mode. The mode selection logic 610 provides the appropriate tracing information 118 from the transaction units 308 to packetizer 612, which includes logic circuits to generate the trace packets 114 to be stored in the trace buffer 110. The filter circuit 600 also includes trigger circuit 614, which receives the trigger signal 1401 and generates the trigger signal 140X. The packetizer 612 may generate the system event indication 142.

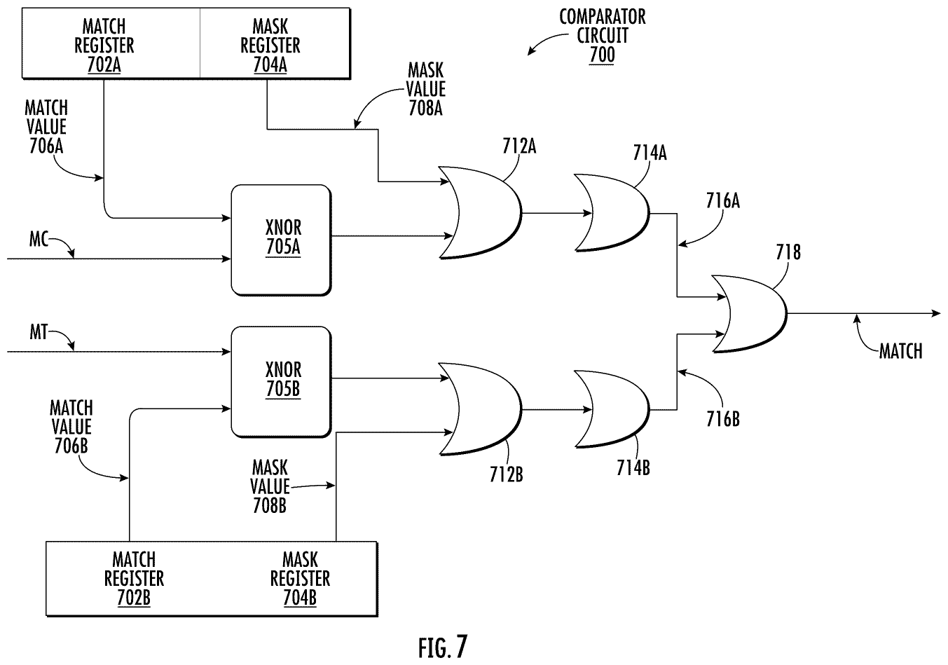

FIG. 7 is a block diagram of a comparator circuit 700, which corresponds to the comparator circuit 604, and is described with reference to FIGS. 1-3B. In FIG. 7, the match register 136 is shown as separate match registers 702A and 702B, and the mask register 138 is shown as separate mask registers 704A and 704B. The match register 702A and mask register 704A contain trace criteria 112 for comparison to the match class MC in the first transaction unit 308 of a packet 102. The match register 702B and mask register 704B contain trace criteria 112 for comparison to the match type MT. Specifically, the match class MC (which may be a multi-bit signal), in a field of the transaction unit 308, is compared (e.g., bit-wise) by an exclusive not OR (XNOR) 705A, in this example, to a match value 706A stored in the match register 702A to generate a first match result 710A. A mask value 708A stored in the mask register 704A is compared to the match result 710A, and if comparisons of the mask bits of the mask value 708A are satisfied, as determined by XNOR 705A and logic circuits 712A and 714A, a match indication 716A of a match to the message class MC is generated. Correspondingly, a match value 706B stored in the match register 702B is provided to XNOR 705B and compared to the match type MT in a second field of the transaction unit 308 to generate a second match result 710B. The second match result 710B is compared to the mask value 708B stored in the mask register 704B using the logic circuits 712B and 714B to generate a match indication 716B, indicating a match to masked bits of the message type MT. When the logic circuit 718 receives both the match indications 716A and 716B, a packet match indication MATCH is generated.

The comparator circuit 700 also corresponds to the comparator circuit 602 except with regard to the number of bits. In the first tracing mode M1, more bits of the transaction units 308 may be compared to the trace criteria 112 to detect a matching transaction unit 312. For example, match values and mask values can be employed to compare to any desired number or desired fields of the transaction units 308.

Electronic devices that include ICs having node circuits at each node of a mesh network and tracing circuits in each node circuit for debugging the IC having memory-mapped trace buffers, as shown in FIGS. 1 and 2 and according to, but not limited to, the exemplary process in FIGS. 3A-3B, and according to any aspects disclosed herein, may be provided in or integrated into any processor-based device. Examples, without limitation, include a set-top box, an entertainment unit, a navigation device, a communications device, a fixed location data unit, a mobile location data unit, a global positioning system (GPS) device, a mobile phone, a cellular phone, a smartphone, a session initiation protocol (SIP) phone, a tablet, a phablet, a server, a computer, a portable computer, a mobile computing device, laptop computer, a wearable computing device (e.g., a smartwatch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

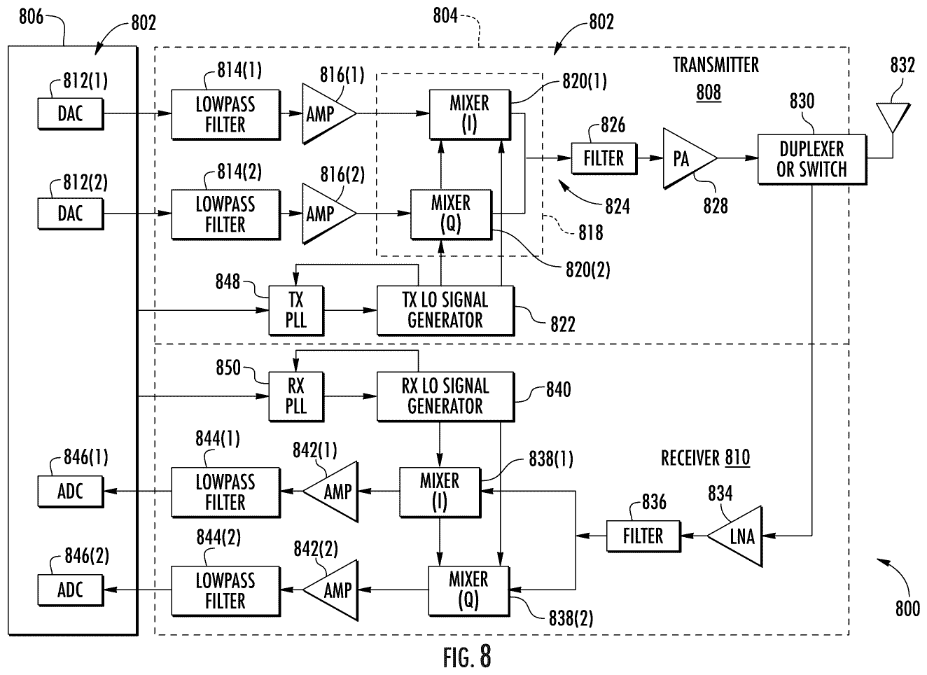

FIG. 8 illustrates an exemplary wireless communications device 800 that includes radio-frequency (RF) components formed from one or more ICs 802, wherein any of the ICs 802 can include ICs having node circuits at each node of a mesh network and tracing circuits in each node circuit for debugging the IC having memory-mapped trace buffers as shown in FIGS. 1 and 2, and according to any exemplary aspects disclosed herein. The wireless communications device 800 may include or be provided in any of the above-referenced devices as examples. As shown in FIG. 8, the wireless communications device 800 includes a transceiver 804 and a data processor 806. The data processor 806 may include a memory to store data and program codes. The transceiver 804 includes a transmitter 808 and a receiver 810 that support bi-directional communications. In general, the wireless communications device 800 may include any number of transmitters 808 and/or receivers 810 for any number of communication systems and frequency bands. All or a portion of the transceiver 804 may be implemented on one or more analog ICs, RF ICs (RFICs), mixed-signal ICs, etc.

The transmitter 808 or the receiver 810 may be implemented with a super-heterodyne architecture or a direct-conversion architecture. In the super-heterodyne architecture, a signal is frequency-converted between RF and baseband in multiple stages, for example, from RF to an intermediate frequency (IF) in one stage and then from IF to baseband in another stage for the receiver 810. In the direct-conversion architecture, a signal is frequency-converted between RF and baseband in one stage. The super-heterodyne and direct-conversion architectures may use different circuit blocks and/or have different requirements. In the wireless communications device 800 in FIG. 8, the transmitter 808 and the receiver 810 are implemented with the direct-conversion architecture.

In the transmit path, the data processor 806 processes data to be transmitted and provides I and Q analog output signals to the transmitter 808. In the exemplary wireless communications device 800, the data processor 806 includes digital-to-analog converters (DACs) 812(1), 812(2) for converting digital signals generated by the data processor 806 into the I and Q analog output signals (e.g., I and Q output currents) for further processing.

Within the transmitter 808, lowpass filters 814(1), 814(2) filter the I and Q analog output signals, respectively, to remove undesired signals caused by the prior digital-to-analog conversion. Amplifiers (AMPs) 816(1), 816(2) amplify the signals from the lowpass filters 814(1), 814(2), respectively, and provide I and Q baseband signals. An upconverter 818 upconverts the I and Q baseband signals with I and Q transmit (TX) local oscillator (LO) signals through mixers 820(1), 820(2) from a TX LO signal generator 822 to provide an upconverted signal 824. A filter 826 filters the upconverted signal 824 to remove undesired signals caused by the frequency up-conversion as well as noise in a receive frequency band. A power amplifier (PA) 828 amplifies the upconverted signal 824 from the filter 826 to obtain the desired output power level and provides a transmit RF signal. The transmit RF signal is routed through a duplexer or switch 830 and transmitted via an antenna 832.

In the receive path, the antenna 832 receives signals transmitted by base stations and provides a received RF signal, which is routed through the duplexer or switch 830 and provided to a low noise amplifier (LNA) 834. The duplexer or switch 830 is designed to operate with a specific receive (RX)-to-TX duplexer frequency separation, such that RX signals are isolated from TX signals. The received RF signal is amplified by the LNA 834 and filtered by a filter 836 to obtain a desired RF input signal. Down-conversion mixers 838(1), 838(2) mix the output of the filter 836 with I and Q RX LO signals (i.e., LO_I and LO_Q) from an RX LO signal generator 840 to generate I and Q baseband signals. The I and Q baseband signals are amplified by AMPs 942(1), 942(2) and further filtered by lowpass filters 844(1), 844(2) to obtain I and Q analog input signals, which are provided to the data processor 906. In this example, the data processor 806 includes analog-to-digital converters (ADCs) 846(1), 846(2) for converting the analog input signals into digital signals to be further processed by the data processor 806.

In the wireless communications device 800 of FIG. 8, the TX LO signal generator 822 generates the I and Q TX LO signals used for frequency up-conversion, while the RX LO signal generator 840 generates the I and Q RX LO signals used for frequency down-conversion. Each LO signal is a periodic signal with a particular fundamental frequency. A TX phase-locked loop (PLL) circuit 848 receives timing information from the data processor 806 and generates a control signal used to adjust the frequency and/or phase of the TX LO signals from the TX LO signal generator 822. Similarly, an RX PLL circuit 850 receives timing information from the data processor 806 and generates a control signal used to adjust the frequency and/or phase of the RX LO signals from the RX LO signal generator 840.

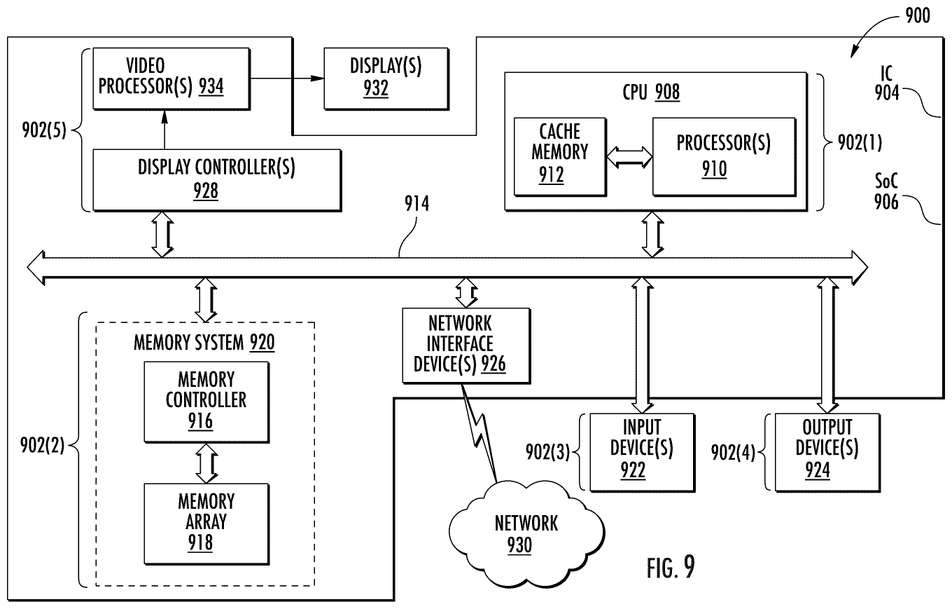

In this regard, FIG. 9 illustrates an example of a processor-based system 900 that can include ICs having node circuits at each node of a mesh network and tracing circuits in each node circuit for debugging the IC having memory-mapped trace buffers as shown in FIGS. 1 and 2, and according to any exemplary aspects disclosed herein. In this example, the processor-based system 900 may be formed as an IC 904, which may be a system-on-a-chip (SoC) 906. The processor-based system 900 includes a central processing unit (CPU) 908 that includes one or more processors 910, which may also be referred to as CPU cores or processor cores. The CPU 908 may have cache memory 912 coupled to the CPU 908 for rapid access to temporarily stored data. The CPU 908 is coupled to a system bus 914 and can intercouple master and slave devices included in the processor-based system 900. As is well known, the CPU 908 communicates with these other devices by exchanging address, control, and data information over the system bus 914. For example, the CPU 908 can communicate bus transaction requests to a memory controller 916, as an example of a slave device. Although not illustrated in FIG. 8, multiple system buses 914 could be provided, wherein each system bus 914 constitutes a different fabric.

Other master and slave devices can be connected to the system bus 914. As illustrated in FIG. 9, these devices can include a memory system 920 that includes the memory controller 916 and a memory array(s) 918, one or more input devices 922, one or more output devices 924, one or more network interface devices 926, and one or more display controllers 928, as examples. Each of the memory system(s) 920, the one or more input devices 922, the one or more output devices 924, the one or more network interface devices 926, and the one or more display controllers 928 can be provided in the same or different electronic devices 902(2)-902(7). The input device(s) 922 can include any type of input device, including, but not limited to, input keys, switches, voice processors, etc. The output device(s) 924 can include any type of output device, including, but not limited to, audio, video, other visual indicators, etc. The network interface device(s) 926 can be any device configured to allow the exchange of data to and from a network 930. The network 930 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 926 can be configured to support any type of communications protocol desired.

The CPU 908 may also be configured to access the display controller(s) 928 over the system bus 914 to control information sent to one or more displays 932. The display controller(s) 928 sends information to the display(s) 932 to be displayed via one or more video processor(s) 934, which processes the information to be displayed into a format suitable for the display(s) 932. The display controller(s) 928 and video processor(s) 934 can be included as ICs in the same or different electronic devices 902(2), 902(3), and in the same or different electronic devices 902 containing the CPU 908, as an example. The display(s) 932 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium wherein any such instructions are executed by a processor or other processing device, or combinations of both. As examples, the devices and components described herein may be employed in any circuit, hardware component, integrated circuit (IC), or IC chip. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic devices, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications, as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

Implementation examples are described in the following numbered clauses:

1. A tracing circuit, comprising:
an input circuit comprising a plurality of inputs, each configured to couple to one of a plurality of ports of a node circuit at a node in a mesh network;
a filter circuit coupled to the input circuit, the filter circuit configured to:
   receive, from the input circuit, transaction units on a selected input of the plurality of inputs;
   compare each of the received transaction units to a trace criteria; and
   in response to a matching transaction unit of the received transaction units matching the trace criteria, generate a trace packet comprising trace information of the matching transaction unit; and
a trace buffer circuit configured to couple to the filter circuit and a trace read interface and configured to:
   receive the trace packet from the filter circuit;
   store the trace packet in a first entry of the trace buffer circuit corresponding to a memory-mapped address;
   receive a read request comprising the memory-mapped address from the trace read interface; and
   provide the trace packet in the first entry of the trace buffer circuit to the trace read interface.
      2. The tracing circuit of clause 1, further comprising:
a read control circuit; and
a read buffer coupled to the read control circuit, wherein the read control circuit is coupled to the trace buffer circuit and configured to:
   access a first trace packet stored in the first entry at the memory-mapped address in the trace buffer circuit;
   store the first trace packet in the read buffer; and
   couple the read buffer to the trace read interface.
      3. The tracing circuit of clause 1 or clause 2, the input circuit further comprising:
a first selection circuit configured to couple to a plurality of ingress ports among the plurality of ports of the node circuit; and
a second selection circuit configured to couple to a plurality of egress ports of the plurality of ports of the node circuit,
wherein the selected one of the plurality of ports of the node circuit comprises one of a selected one of the plurality of ingress ports and a selected one of the plurality of egress ports.
   4. The tracing circuit of any of clause 1 to clause 3, the filter circuit comprising:
a first match register configured to store a first match value; and
a first mask register configured to store a first mask value, wherein:
   the trace criteria comprises the first mask value and the first mask value; and
   the filter circuit is further configured to:
      generate a first match result based on comparisons of a first field of each of the received transaction units to the first match value; and
      generate first match indication based on comparisons of the first match result and the first mask value.
         5. The tracing circuit of clause 4, the filter circuit further comprising:
a second match register configured to store a second match value; and
a second mask register configured to store a second mask value,
wherein:
   the trace criteria further comprises the second mask value and the second mask value; and
   the filter circuit is further configured to:
      generate second match results based on comparisons of a second field of each of the received transaction units to the second match value; and
      generate second match indications based on comparisons of the second match results and the second mask value.
         6. The tracing circuit of clause 4 or clause 5, the filter circuit further comprising:
an exclusive OR circuit configured to generate the first match result based on a bit-wise exclusive OR operation of the first match value and the first field of a first one of the received transaction units; and
an OR circuit configured to generate the first match indication based on an OR operation of the first match result and the first mask value.
   7. The tracing circuit of any of clause 1 to clause 6, further comprising configuration registers configured to store configuration information controlling the input circuit and the filter circuit.
   8. The tracing circuit of any of clause 1 to clause 7, wherein the filter circuit is configured to initiate comparing the received transaction units to the trace criteria in response to receiving a trace trigger signal.
   9. The tracing circuit of clause 8, wherein,
in response to the matching transaction unit matching the trace criteria after the trace trigger signal, the filter circuit stores a timestamp transaction unit that comprises a global timestamp in the trace buffer circuit.
   10. The tracing circuit of clause 8 or clause 9, wherein, in a first tracing mode, the matching transaction unit comprises a first transaction unit of a first packet, and the filter circuit is configured to store each additional transaction unit of the first packet in the trace buffer circuit.
   11. The tracing circuit of clause 8 or clause 9, wherein, in a second tracing mode,
the matching transaction unit comprises a first transaction unit of a first packet;
the trace information stored in the trace buffer circuit comprises:
   transaction packet header information contained in the matching transaction unit; and
   second transaction packet header information contained in a first transaction unit of a second packet matching the trace criteria.
      12. The tracing circuit of clause 8, wherein the filter circuit is configured to stop storing trace packets in the trace buffer in response to receiving the trace trigger signal.
      13. The tracing circuit of clause 1, wherein the filter circuit is configured to:
in response to a first trigger signal:
   store trace packets in a sequence from a first trace entry of the trace buffer to a last trace entry of the trace buffer;
   in response to a first mode:
      stop storing trace packets in the trace buffer; and
   in response to a second mode:
      continue storing trace packets in the sequence in the trace buffer, restarting at the first trace entry, until a second trigger signal is received.
         14. The tracing circuit of clause 13, wherein the filter circuit is configured to, in response to the first mode, generate an indication that a trace packet has been stored in the last trace entry.
         15. The tracing circuit of any of clause 1 to clause 14, wherein the trace information is stored as a trace packet, comprising:
a node identifier identifying the node in the mesh network;
a trace packet type identifier identifying a type of the trace packet;
a port identifier identifying the selected one of the plurality of ports; and
local timestamp information indicating a time of receiving the matching transaction unit.
   16. The tracing circuit of any of clause 1 to clause 15 integrated into a device selected from the group consisting of: a set-top box; an entertainment unit; a navigation device; a communications device; a fixed location data unit; a mobile location data unit; a global positioning system (GPS) device; a mobile phone; a cellular phone; a smartphone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; an avionics system; a drone; and a multicopter.
   17. A method of tracing packets in a mesh network, the method comprising:
receiving, from an input circuit comprising a plurality of inputs, each coupled to one of a plurality of ports of a node circuit at a node in a mesh network, transaction units on a selected one of the plurality of inputs;
comparing each of the received transaction units to a trace criteria;
in response to a matching transaction unit of the received transaction units matching the trace criteria, generating a trace packet comprising trace information of the matching transaction unit;
storing the trace packet in a first entry of a trace buffer circuit corresponding to a memory-mapped address;
receiving a read request comprising the memory-mapped address from a trace read interface; and
returning the trace packet in the first entry of the trace buffer circuit to the trace read interface.
   18. The method of clause 17, further comprising:
accessing, by a read control circuit, a first trace packet stored in the first entry at the memory-mapped address in the trace buffer circuit;
storing the first trace packet in a read buffer coupled to the read control circuit; and
coupling the read buffer to the trace read interface.
   19. The method of clause 17 or clause 18, receiving the transaction units on a selected one of the plurality of inputs further comprising:
selecting, by a first selection circuit, a first one of a plurality of ingress ports among the plurality of ports of the node circuit based on a first control signal; and
selecting, by a second selection circuit, a second one of a plurality of egress ports of the plurality of ports of the node circuit based on a second control signal.
   20. The method of any of clause 17 to clause 19, further comprising:
storing a first match value in a first match register;
storing a first mask value in a first mask register;
generating a first match result based on comparisons of a first field of each of the received transaction units to the first match value; and
generating a first match indication based on comparisons of the first match result and the first mask value.
   21. The method of clause 20, further comprising:
storing a second match value in a second match register;
storing a second mask value in a second mask register;
generating second match results based on comparisons of a second field of each of the received transaction units to the second match value; and
generating second match indications based on comparisons of the second match results and the second mask value.
   22. The method of clause 20, further comprising:
generating the first match result based on a bit-wise exclusive OR operation of the first match value and the first field of a first one of the received transaction units; and
generating the first match indication based on an OR operation of the first match result and the first mask value.
   23. The method of clause any of clause 17 to clause 22, further comprising storing, in a control register, configuration information for controlling the input circuit and the filter circuit.
   24. The method of any of clause 17 to clause 23, further comprising initiating comparisons of the received transaction units to the trace criteria in response to receiving a trace trigger signal.
   25. The method of clause 24, further comprising, in response to one of the transaction units matching the trace criteria after the trace trigger signal, storing a timestamp transaction unit that comprises a global timestamp in the trace buffer circuit.
   26. The method of clause 24, further comprising, in a first tracing mode, in response to the one of the transaction units comprising a first transaction unit of a first packet, storing each additional transaction unit of the first packet in the trace buffer circuit.
   27. An integrated circuit, comprising:
a plurality of node circuits, each comprising a plurality of ports coupled to a mesh network;
a first processing circuit coupled to one of the plurality of node circuits and configured to execute instructions that access data in a range of memory addresses;
a plurality of tracing circuits, each coupled to one of the plurality of node circuits, and each of the tracing circuits comprises:
   an input circuit coupled to the plurality of ports of the node circuit;
   a trace buffer circuit configured to couple to a trace read interface and configured to:
      receive read requests comprising a first memory address, within the range of memory addresses, of a first entry in the trace buffer circuit; and
      provide a trace packet stored at the first entry to the trace read interface; and
   a filter circuit coupled between the input circuit and the trace buffer circuit and configured to:
      receive, from the input circuit, transaction units on a selected one of the plurality of ports;
      compare each of the received transaction units to a trace criteria; and
      in response to a matching transaction unit of the received transaction units matching the trace criteria, store a trace packet comprising trace information of the matching transaction unit in the trace buffer circuit.

What is claimed is:

1. A tracing circuit, comprising:
an input circuit comprising a plurality of inputs, each configured to couple to one of a plurality of ports of a node circuit at a node in a mesh network;
a filter circuit coupled to the input circuit, the filter circuit configured to:
receive, from the input circuit, transaction units on a selected input of the plurality of inputs;
compare each of the received transaction units to a trace criteria; and
in response to a matching transaction unit of the received transaction units matching the trace criteria, generate a trace packet comprising trace information of the matching transaction unit; and
a trace buffer circuit configured to couple to the filter circuit and a trace read interface and configured to:
receive the trace packet from the filter circuit;
store the trace packet in a first entry of the trace buffer circuit corresponding to a memory-mapped address;
receive a read request comprising the memory-mapped address from the trace read interface; and
provide the trace packet in the first entry of the trace buffer circuit to the trace read interface.

2. The tracing circuit of claim 1, further comprising:
a read control circuit; and
a read buffer coupled to the read control circuit,
wherein the read control circuit is coupled to the trace buffer circuit and configured to:
access a first trace packet stored in the first entry at the memory-mapped address in the trace buffer circuit;
store the first trace packet in the read buffer; and
couple the read buffer to the trace read interface.

3. The tracing circuit of claim 1, the input circuit further comprising:
a first selection circuit configured to couple to a plurality of ingress ports among the plurality of ports of the node circuit; and
a second selection circuit configured to couple to a plurality of egress ports of the plurality of ports of the node circuit,
wherein the selected one of the plurality of ports of the node circuit comprises one of a selected one of the plurality of ingress ports and a selected one of the plurality of egress ports.

4. The tracing circuit of claim 1, the filter circuit comprising:
a first match register configured to store a first match value; and
a first mask register configured to store a first mask value,
wherein:
the trace criteria comprises the first mask value and the first mask value; and
the filter circuit is further configured to:
generate a first match result based on comparisons of a first field of each of the received transaction units to the first match value; and
generate first match indication based on comparisons of the first match result and the first mask value.

5. The tracing circuit of claim 4, the filter circuit further comprising:
a second match register configured to store a second match value; and
a second mask register configured to store a second mask value,
wherein:
the trace criteria further comprises the second mask value and the second mask value; and
the filter circuit is further configured to:
generate second match results based on comparisons of a second field of each of the received transaction units to the second match value; and
generate second match indications based on comparisons of the second match results and the second mask value.

6. The tracing circuit of claim 4, the filter circuit further comprising:
an exclusive OR circuit configured to generate the first match result based on a bit-wise exclusive OR operation of the first match value and the first field of a first one of the received transaction units; and
an OR circuit configured to generate the first match indication based on an OR operation of the first match result and the first mask value.

7. The tracing circuit of claim 1, further comprising configuration registers configured to store configuration information controlling the input circuit and the filter circuit.

8. The tracing circuit of claim 1, wherein the filter circuit is configured to initiate comparing the received transaction units to the trace criteria in response to receiving a trace trigger signal.

9. The tracing circuit of claim 8, wherein,
in response to the matching transaction unit matching the trace criteria after the trace trigger signal, the filter circuit stores a timestamp transaction unit that comprises a global timestamp in the trace buffer circuit.

10. The tracing circuit of claim 8, wherein, in a first tracing mode, the matching transaction unit comprises a first transaction unit of a first packet, and the filter circuit is configured to store each additional transaction unit of the first packet in the trace buffer circuit.

11. The tracing circuit of claim 8, wherein, in a second tracing mode,
the matching transaction unit comprises a first transaction unit of a first packet;
the trace information stored in the trace buffer circuit comprises:
transaction packet header information contained in the matching transaction unit; and
second transaction packet header information contained in a first transaction unit of a second packet matching the trace criteria.

12. The tracing circuit of claim 8, wherein the filter circuit is configured to stop storing trace packets in the trace buffer in response to receiving the trace trigger signal.

13. The tracing circuit of claim 1, wherein the filter circuit is configured to:
in response to a first trigger signal,
store trace packets in a sequence from a first trace entry of the trace buffer to a last trace entry of the trace buffer;
in response to a first mode:
stop storing trace packets in the trace buffer; and
in response to a second mode:
continue storing trace packets in the sequence in the trace buffer, restarting at the first trace entry, until a second trigger signal is received.

14. The tracing circuit of claim 13, wherein the filter circuit is configured to, in response to the first mode, generate an indication that a trace packet has been stored in the last trace entry.

15. The tracing circuit of claim 1, wherein the trace information is stored as a trace packet, comprising:
a node identifier identifying the node in the mesh network;
a trace packet type identifier identifying a type of the trace packet;
a port identifier identifying the selected one of the plurality of ports; and
local timestamp information indicating a time of receiving the matching transaction unit.

16. The tracing circuit of claim 1 integrated into a device selected from the group consisting of: a set-top box; an entertainment unit; a navigation device; a communications device; a fixed location data unit; a mobile location data unit; a global positioning system (GPS) device; a mobile phone; a cellular phone; a smartphone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; an avionics system; a drone; and a multicopter.

17. A method of tracing packets in a mesh network, the method comprising:
receiving, from an input circuit comprising a plurality of inputs, each coupled to one of a plurality of ports of a node circuit at a node in a mesh network, transaction units on a selected one of the plurality of inputs;
comparing each of the received transaction units to a trace criteria;
in response to a matching transaction unit of the received transaction units matching the trace criteria, generating a trace packet comprising trace information of the matching transaction unit;
storing the trace packet in a first entry of a trace buffer circuit corresponding to a memory-mapped address;
receiving a read request comprising the memory-mapped address from a trace read interface; and
returning the trace packet in the first entry of the trace buffer circuit to the trace read interface.

18. The method of claim 17, further comprising:
accessing, by a read control circuit, a first trace packet stored in the first entry at the memory-mapped address in the trace buffer circuit;
storing the first trace packet in a read buffer coupled to the read control circuit; and
coupling the read buffer to the trace read interface.

19. The method of claim 17, receiving the transaction units on a selected one of the plurality of inputs further comprising:
selecting, by a first selection circuit, a first one of a plurality of ingress ports among the plurality of ports of the node circuit based on a first control signal; and
selecting, by a second selection circuit, a second one of a plurality of egress ports of the plurality of ports of the node circuit based on a second control signal.

20. The method of claim 17, further comprising:
storing a first match value in a first match register;
storing a first mask value in a first mask register;
generating a first match result based on comparisons of a first field of each of the received transaction units to the first match value; and
generating a first match indication based on comparisons of the first match result and the first mask value.

21. The method of claim 20, further comprising:
storing a second match value in a second match register;
storing a second mask value in a second mask register;
generating second match results based on comparisons of a second field of each of the received transaction units to the second match value; and
generating second match indications based on comparisons of the second match results and the second mask value.

22. The method of claim 20, further comprising:
generating the first match result based on a bit-wise exclusive OR operation of the first match value and the first field of a first one of the received transaction units; and
generating the first match indication based on an OR operation of the first match result and the first mask value.

23. The method of claim 17, further comprising storing, in a control register, configuration information for controlling the input circuit and the filter circuit.

24. The method of claim 17, further comprising initiating comparisons of the received transaction units to the trace criteria in response to receiving a trace trigger signal.

25. The method of claim 24, further comprising, in response to one of the transaction units matching the trace criteria after the trace trigger signal, storing a timestamp transaction unit that comprises a global timestamp in the trace buffer circuit.

26. The method of claim 24, further comprising, in a first tracing mode, in response to the one of the transaction units comprising a first transaction unit of a first packet, storing each additional transaction unit of the first packet in the trace buffer circuit.

27. An integrated circuit, comprising:
a plurality of node circuits, each comprising a plurality of ports coupled to a mesh network;
a first processing circuit coupled to one of the plurality of node circuits and configured to execute instructions that access data in a range of memory addresses;
a plurality of tracing circuits, each coupled to one of the plurality of node circuits, and each of the tracing circuits comprises:
an input circuit coupled to the plurality of ports of the node circuit;
a trace buffer circuit configured to couple to a trace read interface and configured to:
receive read requests comprising a first memory address, within the range of memory addresses, of a first entry in the trace buffer circuit; and
provide a trace packet stored at the first entry to the trace read interface; and
a filter circuit coupled between the input circuit and the trace buffer circuit and configured to:
receive, from the input circuit, transaction units on a selected one of the plurality of ports;
compare each of the received transaction units to a trace criteria; and
in response to a matching transaction unit of the received transaction units matching the trace criteria, store a trace packet comprising trace information of the matching transaction unit in the trace buffer circuit.
